(19) United States
(12) Patent Application Publication
(10) Pub. No.: US 2021/0107186 A1
(43) Pub. Date: Apr. 15, 2021

(54) COOLING METHOD AND COOLING DEVICE OF MOLDED RESIN PRODUCTS

(71) Applicant: UNIPRES CORPORATION, Yokohama-shi, Kanagawa (JP)

(72) Inventors: Katsuhisa ENDOH, Shizuoka (JP); Masato USAMI, Shizuoka (JP)

(73) Assignee: UNIPRES CORPORATION, Yokohama-shi, Kanagawa (JP)

(21) Appl. No.: 16/498,696

(22) PCT Filed: Mar. 12, 2018
(86) PCT No.: PCT/JP2018/009408

§ 371 Date: Sep. 27, 2019

(30) Foreign Application Priority Data
Mar. 28, 2017 (JP) 2017-063099

(51) Int. Cl. B29C 43/52; B29C 43/50

(52) U.S. Cl. CPC B29C 43/52; B29C 2043/527; B29C 43/50

(57) ABSTRACT

The present invention relates to a cooling method and a cooling device of molded resin products which are made from a synthetic resin as a raw material and are ejected from a press molding apparatus. An object of the present invention is to shorten a molding time and ensure product quality. A molded resin product M which is ejected from a die in a still hot state is supplied on plural jigs 30 on a rotational stage 26 in a cooling chamber 24 from an inlet 34. Dry mist F is sprayed from nozzles 60 of spraying units disposed at upper portions of the cooling chamber 24 to the molded resin product M. The dry mist F sprayed from the nozzles 60 to the molded resin product M is vaporized under a heat amount in which the molded resin product M has. Thereby, the heat is removed from the molded resin product M, and the cooled molded resin product M is ejected from the outlet 38 without adhesion of a water droplet. The dry mist is sprayed in a state that the cooling chamber 24 is closed. The molded resin product M during cooling is mounted on the jig 30 for preventing deformation due to gravity.

### TECHNICAL FIELD

The present invention relates to a cooling method and a cooling device of molded resin products which are made from a synthetic resin as a raw material, and are molded by and are ejected from a press molding apparatus.

### BACKGROUND ART

In order to manufacture synthetic resin articles for a vehicle such as an inner fender and an undercover by press molding, it is known that a press molding method of molded resin products (hereinafter referred to as “a temperature-controlled sheet piece press molding method”), which are shaped to a desired shape from a sheet piece, is performed by controlling a temperature of the sheet piece to the temperature in which the sheet piece has low rigidity (flexibility) to perform the press molding, supplying the sheet piece to a space between an upper die and a lower die of the press molding apparatus, and being combined with the upper die and the lower die (Patent Document 1). In contrast, in order to shorten the cycle time of the press molding apparatus and improve productivity, shortening of the molding time per one cycle is an effective means. In order to shorten the molding time per one cycle, ejecting the molded resin product from the die early (in a state that the resin is still hot), and forcibly cooling the molded resin product by air flow from a cooling fan is normally and often performed. For the forcibly cooling, the molded resin products from the die are ejected to a conveyor, the plural cooling fans are disposed opposite to the conveyor, and the forcibly cooling of the molded resin products on the conveyor is performed by the air flow from the cooling fans. Patent Document 2 discloses the forcibly cooling of the molded resin products by the air flow from the cooling fans. However, the cooling method in Patent Document 2 is not with reference to the cooling in the above-described temperature-controlled sheet piece press molding method, but with reference to the cooling of the molded resin product in the press molding by an injection molding method. As the cooling of the molded resin product by dry mist which is related technology of the present invention, the cooling of the blow molded resin products in the die for the blow molding is disclosed in Patent Document 3. Further, an ultrafine spray forming nozzle to obtain the ultrafine mist (that is, the dry mist) is disclosed in Patent Documents 4 and 5, and the like.

### THE LIST OF PRIOR ART DOCUMENTS

### Patent Documents

Patent Document 1: Japanese Unexamined Patent Publication No. S64-40311 A
Patent Document 2: Japanese Unexamined Patent Publication No. H10-24474 A
Patent Document 3: Japanese Unexamined Patent Publication No. 2000-141463 A
Patent Document 4: Japanese Unexamined Patent Publication No. S62-289257 A
Patent Document 5: Japanese Unexamined Patent Publication No. H05-208148 A

### SUMMARY OF THE INVENTION

### Problems to be Solved by the Invention

In the cooling of the molded resin products by the cooling fans, the temperature of the cooling air is easily affected from the variation of the outside air temperature depending on seasons. Thereby, it has a problem that the influence to the product quality such as the deviation of the shape dimension accuracy caused by deformation is significant. Moreover, the molded resin products when being ejected from the press molding apparatus have the low rigidity due to the high temperature, and are easily deformed by the influence of gravity due to the self-weight during conveying the molded resin products on the conveyor. This is concerned about the influence to the product quality. The present invention has been developed in view of the above-described circumstances, and an object of the present invention is to shorten the molding time and ensure the product quality.

### Means for Solving the Problems

Usually the molded resin products are held by dies until the resin becomes cold enough. According to the present invention, the cooling method of the molded resin products by spraying the mist to the molded resin products that are ejected from the molding apparatus in which the synthetic resins are molded under the heating condition and are still the hot state, cooling down the molded resin products by vaporizing the sprayed mist to the molded resin products under the heat amount that the molded resin products have, and cooling the molded resin products not to substantially adhere the water droplet to the molded resin products, is provided. In the present invention, it is preferred that an average particle diameter of the mist be 10 [μm] or less. By spraying the mist having such a particle diameter to the hot molded resin products ejected from the molding apparatus, the mist is vaporized by the heat of the molded resin products without condensing the mist as a water droplet. Therefore, the above method is commonly called as “dry mist”. As the nozzle for obtaining the dry mist, the nozzle in which the mist having the fine particle diameter is formed by colliding the high pressure air flow to the water flow, can be adopted. Various nozzle types are proposed as such a nozzle. The nozzle in which the water injected from nozzle holes disposed inclinedly and oppositely is collided in a state of being surrounded by the air so as to inject the fine particle mist forwardly, can be adopted (see, Patent Documents 4 and 5).

It is preferred that the molded resin products be received in a substantially closed space when spraying the dry mist to the molded resin product, the molded resin products ejected from the molding apparatus be supplied into the above-described space so as to sequentially receive the molded resin products, the molded resin products in which the cooling is completed be ejected from the cooling space, and the cooling for the plural molded resin products be simultaneously performed by mounting the plural molded resin products in the above-described space. It is also preferred that the water vapor in the above-described space be forcibly ventilated. By spraying the mist to the molded resin products in the substantially closed space, leaking the mist to an exterior of the above-described space can be prevented. The trouble such as the occurrence of rust due to dew condensation to the mechanical equipment such as the press molding apparatus which is adjacently disposed, and the wall of the building, can also be prevented. In the present invention, it is preferred that the molded resin products be mounted on the jigs which the surfaces are same shapes as the final products while the dry mist cooling is done. Since the present invention provides remarkably high cooling efficiency, it enables to shorten the die cooling time. The ejected products are hot enough to deform by the gravity because the resin loses its rigidity as it gets hot. However, the present invention prevents the deformation by using the jigs while dry mist spraying is done. Thus, the products meet the quality requirements/specifications of tolerance of the shape.

According to the present invention, a cooling device of molded resin products by the dry mist, comprising: a cooling chamber that receives the molded resin products, forms a space where cooling of the molded resin products is performed, and has an inlet for the molded resin products and an outlet for the cooled molded resin products which are openable and closable by respective doors, a rotational stage that is rotated around a vertical axis in the cooling chamber, plural jigs that are disposed on the rotational stage, hold shapes of the molded resin products, and retain the molded resin products to predetermined positions, and a dry mist spraying apparatus that is disposed at an upper portion of the cooling chamber and sprays the dry mist to the molded resin products retained by the jigs, can be provided.

The present invention improves the efficiency of cooling down of the molded resin products because the dry mist spraying is done while the plural jigs on the rotatory stage are rotating. The rotatory stage is controlled to stop and the doors are opened while the molded resin products are carried in and out. The door for inlet is located nearby the molding apparatus. The doors are opened when the rotatory stage stops and are closed while the rotatory stage is rotating. The molded resin products are picked out from the molding apparatus (dies) and carry into the cooling chamber when the molding cycle is ended. The rotatory stage starts to rotate and dry mist spraying begins in every chamber. Dry mist spraying is stopped in the chamber at the inlet and outlet door positions while the rotatory stage stops. However, in the other chamber, dry mist spraying is continued while the rotatory stage stops. Thus, the molded resin products ejected from the molding apparatus supply to cooling apparatus through the inlet door one after another and completely cooled products are picked out through the outlet door.

### Effects of the Invention

The molded resin products are cooled down by using the phenomenon of latent heat of vaporization that takes heat away when the liquid is vaporized. Vaporization of the dry mist on the molded resin products is so rapid that the mist on the products cannot gather to grow up a waterdrop. As the cool down speed is faster than current way, so it is possible to eject the molded resin products from the molding apparatus earlier. Since the cycle of the molding process is synchronized with the cooling process, shortening the molding process provides higher productivity and cost down with compact apparatus of cooling.

The jigs which support the molded resin products while cooling have same the shape of surface with final products. The molded resin products just ejected from the molding apparatus are still hot and soft enough, so the molded resin products are closely contact with the jigs. Since the molded resin products are closely contact with the jigs while cooling, so it minimizes the quality defects of the products. By performing the cooling of the molded resin products in the substantially closed space, the product quality variation factors such as the external temperature can be reduced. In cases of thick plate products and articles having an uneven thickness, parameters such as water pressure, a water amount and pneumatic pressure can adequately be adjusted. Compared with the manufacturing line for the cooling by the conventional conveyor, the cooling system by the rotational stage can be compact in size of the equipment.

### BRIEF DESCRIPTION OF THE DRAWINGS

In the accompanying drawings:

FIG. 1 is a schematic layout diagram of a press molding equipment of an inner fender for a vehicle as a resin component for the vehicle;

FIG. 2 is a schematic cross-sectional view of the press molding apparatus in FIG. 1 (a cross-sectional view taken along a line II-II in FIG. 1);

FIGS. 3A and 3B are schematic perspective views of the inner fender for the vehicle which is manufactured by the press molding apparatus in FIG. 2, FIG. 3A shows an integrated shape of the left and right inner fenders when ejected from the molding apparatus, and FIG. 3B shows shapes separated to the left and right inner fenders after performing trimming press;

FIG. 4 is an enlarged view of the cooling device in the press molding equipment in FIG. 1 (a cross-sectional view taken along a line IV-IV in FIG. 5);

FIG. 5 is a longitudinal cross-sectional view of the cooling device when a rotational stage is a stop position (across-sectional view taken along a line V-V in FIG. 4);

FIG. 6 is a cross-sectional view taken along a line IV-IV in FIG. 5 as well as FIG. 4, in a state that the rotational stage rotates by 60 [deg] from the stop position in FIG. 4;

FIG. 7 is a longitudinal cross-sectional view of the cooling device when the rotational stage is the stop position (a cross-sectional view taken along a line VII-VII in FIG. 5);

FIG. 8 is a schematically and partially broken side view showing a structure of one nozzle which is used in a spraying unit;

FIG. 9 is a schematic cross-sectional view of a forcible discharge unit of water vapor;

FIG. 10 is a schematic timing chart showing that an operation of the molding apparatus interlocks with operations of a rotational stage, jigs and the spraying unit; and

FIG. 11 is a graph showing a temperature variation from setting a raw material to the molding apparatus.

### MODE FOR CARRYING OUT THE INVENTION

An embodiment of the present invention will be described in a case of performing cooling of molded resin products ejected from a die of a press molding apparatus in press molding depending on a temperature-controlled sheet piece press molding method disclosed in Patent Document 1. However, the present invention is not limited to the press molding resin products depending on this press molding method, and can perform the cooling of the molded resin products which are press-molded by an injection molding method and the general cooling of the molded resin products which are ejected from the die and have high temperature. Further, the following embodiment will be described to the resin components such as an inner fender and an undercover. However, the present invention is not limited to application to the above products, and can be applicable to the general resin components.

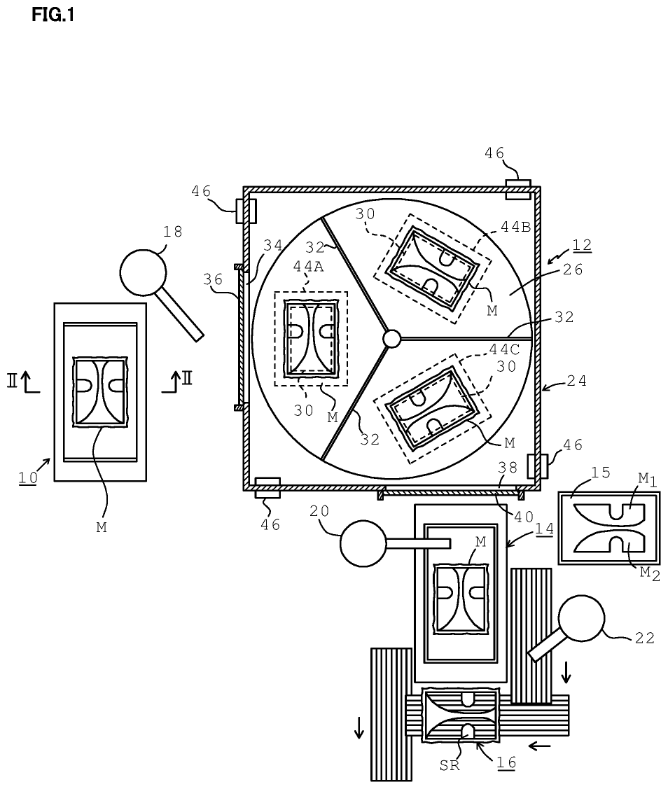

FIG. 1 shows a schematic layout of a press molding equipment of the resin components for the vehicle such as the inner fender and the undercover. This press molding equipment performs the press molding of a temperature-controlled sheet piece whose temperature is about 120° Celsius in a case of the temperature in which the press molding can be performed (the resin material is polypropylene, and for adjusting a melting point, a small amount of other materials such as polyethylene can be contained). In FIG. 1, the equipment for forming the temperature-controlled sheet piece is not shown. As described in Patent Document 1, the equipment that manufactures a temperature-controlled sheet piece by melting the synthetic resin materials such as polypropylene and polyethylene (the main ingredient is a chip, and the rest is scraps), extruding the sheets from dies, cutting the sheet to the sheet pieces having a predetermined length, and additionally heating the sheet pieces if necessary, is disposed. In FIG. 1, the reference numeral 10 denotes a press molding apparatus (a molding press) which produces a molded resin product from the sheet piece by the die, the reference numeral 12 denotes a cooling device of the molded resin products by the dry mist, the reference numeral 14 denotes a press apparatus for trimming of the press molded resin products (a trimming press), the reference numeral 15 denotes a workbench for the molded resin product after trimming, the reference numeral 16 denotes a conveyor for the scraps which are produced by trimming, and the reference numerals 18, 20 and 22 denote an articulated manipulator (a robot) for handling the molded resin products. Here, in the present invention, the dry mist indicates the mist whose average diameter is 10 [μm] or less. In a case that the mist is sprayed to the molded resin product, a heat amount in which the molded resin product holds is vaporized, the heat is removed from the molded resin product by the latent heat of vaporization, and the cooling for the molded resin product can be performed without adhesion of the water droplet.

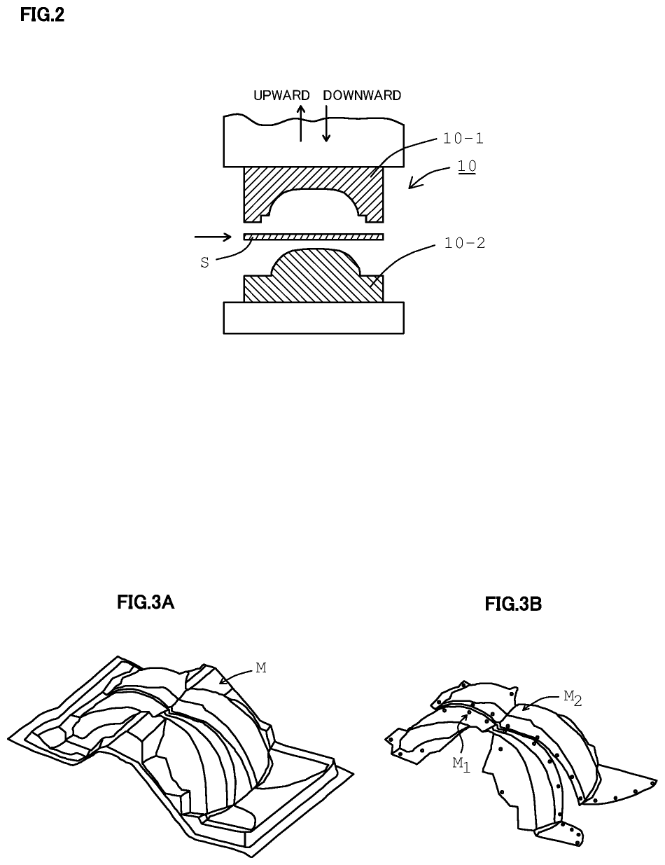

As schematically shown in FIG. 2, the molding press 10 comprises an upper die 10-1 and a lower die 10-2, and the upper die 10-1 is coupled to a crank press (not shown). The temperature-controlled sheet piece S is supplied between the upper die 10-1 and the lower die 10-2. The upper die 10-1 lowers toward the lower die 10-2, and by combining the both dies, the sheet piece S is press-molded to a shape of an integrated molded resin product M (hereinafter referred to as “a molded resin product”) which is to be the inner fender after trimming. A particular shape of the molded resin product M ejected from the molding press 10 is schematically shown in FIG. 3A. In this state of the present embodiment, the left and right resin inner fenders for the front wheels of the vehicle are integrated, and the above inner fenders can be obtained by press-molding the temperature-controlled sheet S whose material is polypropylene and the like using the molding press 10. In a state that the molded resin product M is still hot and is required for the cooling (the temperature is about 70° Celsius in a case of polypropylene), the upper die 10-1 is lifted (the dies are opened), the molded resin product M is carried in an interior of the dry mist cooling device 12 by the robot 18, and as described below, the molded resin product is cooled to a desired temperature (the temperature is about 40° Celsius in a case of polypropylene) by spraying the dry mist without the adhesion of the water droplet. The molded resin product M after cooling is ejected from the dry mist cooling device 12 by the robot 20 and the trimming to the molded resin product M is performed by the trimming press 14. A state of the inner fenders after completing the trimming by the trimming press 14 is schematically shown in FIG. 3B. Unnecessary portions are trimmed from the molded resin product M (FIG. 3A) (The molded resin product M is cut along an outline of the needed molded resin product), the molded resin product M is separated to the left and right inner fenders M₁ and M₂, and the inner fenders M₁ and M₂ are mounted on the workbench 15 once, as shown in FIG. 1. The robot 22 ejects the inner fenders M₁ and M₂ from the molded resin product M, and the scraps SR which are exhausted after the inner fenders M₁ and M₂ are taken out from the molded resin product M, are conveyed to a resin recovery apparatus (not shown) through the scrap conveyor 16. In the resin recovery apparatus, the scraps SR is reused as the raw resin material for molding the molded resin product M in the molding press 10.

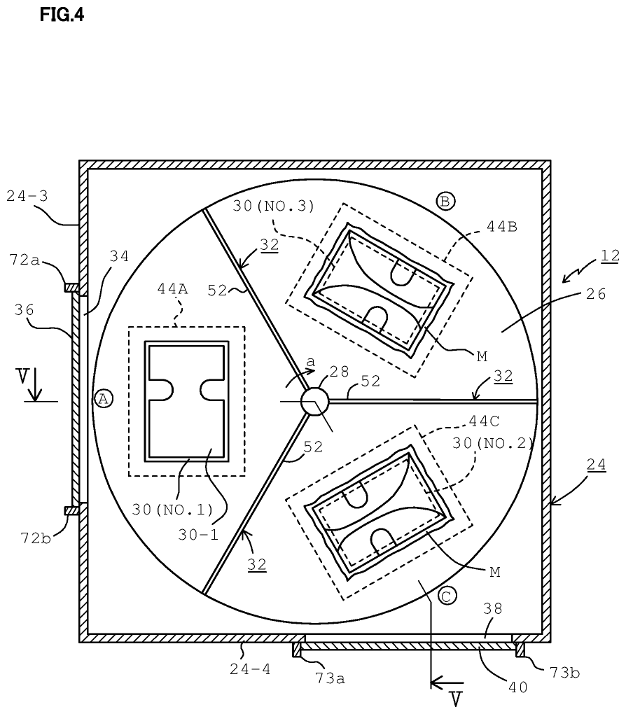

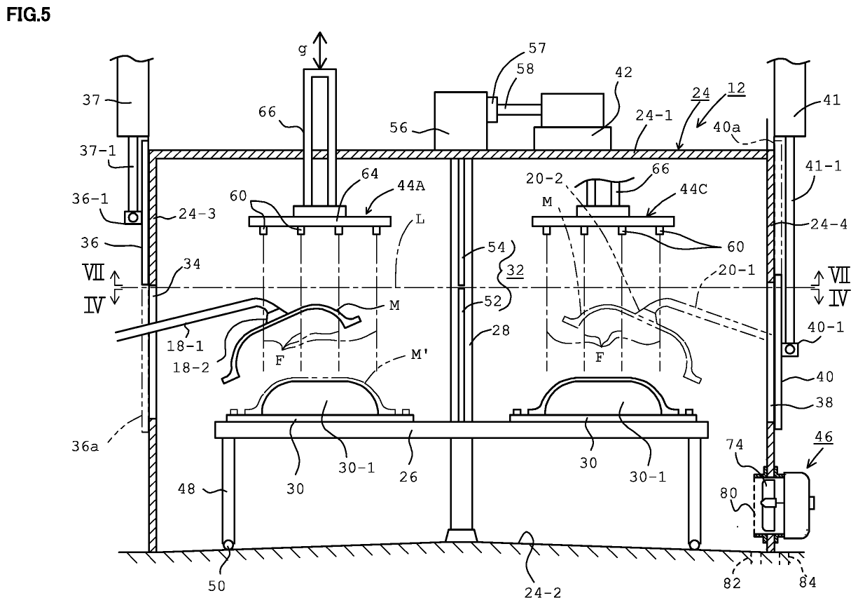

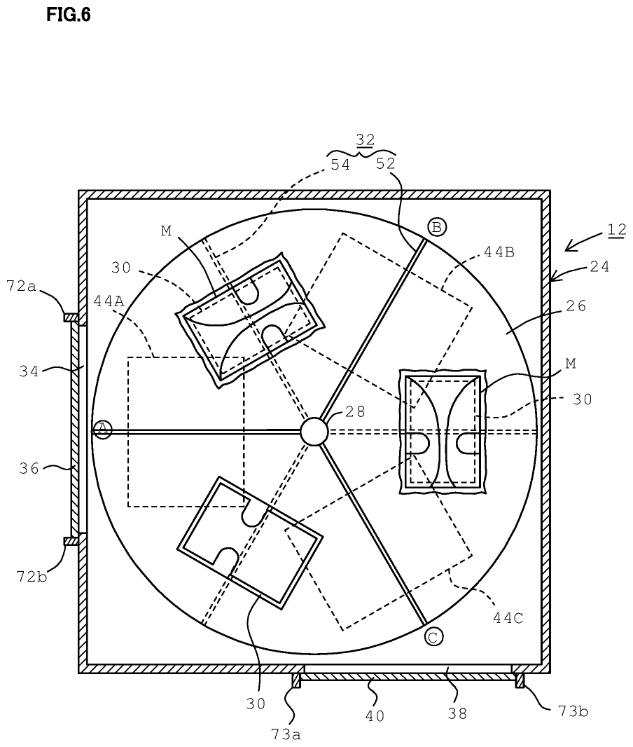

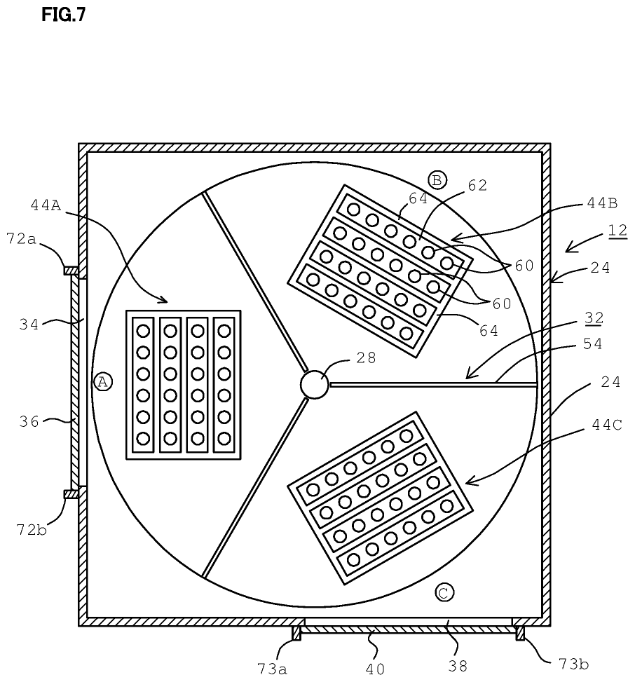

The configuration of the dry mist cooling device 12 for the molded resin products in the present embodiment of the present invention will be described. As shown in FIGS. 4 and 5, the dry mist cooling device 12 comprises a rectangular parallelepiped cooling chamber 24, a rotational stage 26, a support 28 whose upper and lower ends are pivotally supported by the upper and lower walls 24-1 and 24-2 of the cooling chamber 24, respectively, and which is fixed to the rotational stage 26, three jigs 30 for holding the molded resin products (hereinafter referred to as “jigs”) which are fixed with a 120 [deg] equal interval each other on the rotational stage 26, and mount and hold the hot soft molded resin products ejected from the molding press 10 so that the molded resin products are not deformed by the influence of the gravity due to self-weight, dividing walls 32 which are disposed with a 120 [deg] interval each other between the adjacent jigs 32 in a vertical direction, and rotate in an arrow “a” direction in FIG. 4, an rectangular inlet 34 for setting the molded resin products, which is disposed at a side wall 24-3 of the cooling chamber 24 opposite to the molding press 10, a door 36 which opens or closes the inlet 34 by lifting or lowering, a pneumatic pressure cylinder 37 for opening and closing the door 36, an outlet 38 for ejecting the molded resin products, which is disposed at a side wall 24-4 of the cooling chamber 24 opposite to the trimming press 14 (FIG. 1), a door 40 which opens or closes the outlet 38 by lifting or lowering, a pneumatic pressure cylinder 41 for opening and closing the door 40, a driving electric motor 42 which is disposed at the upper wall 24-1 of the cooling chamber 24, rotates the support 28, resulting in rotating the rotational stage 26, in other words, rotating the jigs 30 on the rotational stage 26, three spraying unit 44A, 44B and 44C which are disposed above the jigs 30 in the cooling chamber 24 with a 120 [deg] interval each other, as shown in FIG. 7, and as described below, constitute the dry mist spraying apparatus which sprays the dry mist to the molded resin products M held by the jigs 30, and a discharge unit 46 for forcibly discharging the air of the cooling chamber 24.

Next, the above-described components of the dry mist cooling device 12 will be described in detail. In FIG. 5, the lower surface of the rotational stage 26 is fixed by support stands 48, and the support stands 48 are mounted on the bottom wall surface 24-2 of the cooling chamber through casters 50. Thereby, smooth rotational operation of the rotational stage 26 can be realized. The bottom wall surface 24-2 of the cooling chamber 24 has an inclined surface toward the outer circumference. The inclined structure of the bottom wall surface 24-2 will be described in relation to the discharge unit 46 as described below.

The dividing walls 32 comprise a rotational unit 52 fixed to the support 28 and the fixed unit 54 fixed to the lower surface of the upper wall 24-1 of the cooling chamber 24. The rotational unit 52 extends from the outer circumference surface of the support 28 to the outer circumference surface of the rotational stage 26 in a radial direction between the adjacent jigs 30 (FIG. 4). As shown in FIG. 5, a slight space is existed between the upper surface of the rotational unit 52 and the lower surface of the fixed unit 54 so as not to prevent from the rotation of the rotational unit 52.

A transmission 56 is disposed at the upper end of the support 28 extending from the upper wall 24-1 of the cooling chamber 24 to an exterior. Since the transmission 56 is well-known, the structure of the transmission 56 is not shown. Basically, the transmission 56 has pinion gears of the output side (the support 28 side) and warm gears of the input side, and reduces the rotational velocity of the input member 57 of the transmission 56 coupled to the warm gears, and can transmit the reduced rotation to the support 28. In contrast, the rotational shaft of the electric motor 42 is coupled to the output shaft 58 which is coupled to the input member 57 of the transmission 56 through the appropriate internal gears. The rotational velocity of the rotational shaft of the electric motor 42 is reduced and the reduced rotation is transmitted to the support 28. The rotational stage 26 is rotated by the rotation of the support 28, the jigs 30 on the rotational stage 26 rotate at an appropriate velocity in the cooling chamber 24, the mist is sprayed to the molded resin products held by the jigs 30 during the rotational period, and then the cooling of the molded resin products are performed.

Next, a relationship among the rotational position of the jigs 30 by the rotation of the rotational stage 26, the inlet 34 and the outlet 38 will be described. For convenience of the explanation, three jigs disposed on the rotational stage are numbered as No. 1, No. 2 and No. 3 for distinguishing (FIG. 4). In the jigs 30 which are numbered as No. 1, No. 2 and No. 3, the jig No. 1 is in an empty state in which the molded resin product M is not set, and is shown by a solid line, and the jigs No. 2 and No. 3 are in a state in which the molded resin product M is mounted, and are shown by a broken line. FIG. 1 shows that all of the jigs 30 (No. 1, No and No. 3) are in a state in which the molded resin product M is set. FIG. 4 shows one of the stop positions occurred by rotating the rotational stage 26 by 120 [deg] as described above. In this case, the No. 1 jig 30 which is one of the jigs 30 for holding is positioned to an setting position “A” faced on the inlet 34, the No. 3 jig 30 is positioned to an intermediate position “B” adjacent in the rotational direction (spaced with 120 [deg]), and the No jig 30 is an ejecting position “C” for the molded resin product, which is faced on the outlet 38. Here, the setting position “A” for setting the molded resin product, the intermediate position “B” and the ejecting position “C” for the molded resin product mean the fixed positions (the stop positions) in an interior of the cooling chamber 24, which are spaced with 120 [deg] each other in a rotational direction against the vertical center (the rotational center). In the stop positions of the rotational stage in FIG. 4, as shown in FIG. 5, the door 36 for the inlet 34 is opened, and the preparation for setting the molded resin product M, which is moved from the molding press 10, to the jig 30 which is positioned at the setting position “A”, is performed. The door 40 for the outlet 38 is also opened, and the preparation for ejecting the molded resin product M in which the cooling is completed, from the jig 30 which is positioned at the ejecting position “C” for the molded resin product, is performed. As shown in FIG. 5, in the stop positions of the rotational stage 26 in FIG. 4, the rotational unit 52 of the dividing wall 32, which is fixed to the support 28, is alignment with the fixed unit 54 of the dividing wall 32, which is fixed to the lower surface of the upper wall 24-1 of the cooling chamber 24. The molded resin product M is set to the jig 30 at the setting position “A”, the molded resin product M in which the cooling is completed, is ejected from the jig 30 at the ejecting position “C” for the molded resin product, and the rotational stage 26 rotates by 120 [deg]. The No. 2 jig 30 which was positioned at the ejecting position “C” for the molded resin product in FIG. 4 is moved to the setting position “A” and can receive the new molded resin product for which the cooling is needed, from the molding press 10. The No. 3 jig 30 which was positioned at the intermediate position “B” is moved to the ejecting position “C” for the molded resin product, and the ejection of the molded resin product is performed. The No. 1 jig 30 which was positioned at the setting position “A” is moved to the intermediate position “B”. By repeating the stop operation of the rotational stage 26 and the rotation operation of the rotational stage 26, setting the molded resin product for which the cooling is needed and ejecting the molded resin product in which the cooling is completed are sequentially performed.

During such a rotation of the rotational stage 26, the rotational unit 52 of the dividing wall 32 rotates with the rotational stage 26, and the fixed unit 54 of the dividing wall 32 does not rotate. Thus, the relative position between the rotational unit 52 and the fixed unit 54 is varied during the rotation of the rotational stage 26. At the stop position of FIG. 4, the rotational unit 52 is alignment with the fixed unit 54 in the vertical direction. The rotational angle (the interval) of the rotational unit 52 to the fixed unit 54 increases by the rotation of the rotational stage 26 from the stop position. As shown in FIG. 6, when the rotational stage 26 rotates by 60 [deg] from the stop position, the fixed unit 54 is positioned at the intermediate position between the adjacent rotational units 52, and a space between the rotational unit 52 and the fixed unit 54 becomes the maximum value. However, when the rotational stage 26 further rotates by 60 [deg], the rotational unit 52 is alignment with the fixed unit 54 again.

Next, in the present invention, the ultrafine mist from the nozzle 60 described below is sprayed to the molded resin products for cooling the molded resin products ejected from the molding press 10. Thereby, the water droplet is not adhered to the molding resin products which are the cooling objects, the mist is vaporized to the water vapor, and the molded resin products are efficiently cooled by the latent heat. In the present embodiment, the dry mist spraying apparatus comprises three spraying units 44A, 44B and 44C. The spraying units 44A, 44B and 44C are fixedly disposed at the setting position “A”, the intermediate position “B” and the ejecting position “C” for the molded resin product in an interior of the cooling chamber 24, respectively (refer to FIGS. 6 and 7). Accordingly, when the rotational stage 26 is moved to the stop position (FIG. 4), the spraying units 44A, 44B and 44C are positioned above the respective jigs 30. As shown in FIG. 7, the spraying units 44A, 44B and 44C are positioned between the adjacent fixed units 54 in the dividing walls 32 in a circumferential direction. The configuration of the spraying unit 44A, 44B and 44C will be described. The spraying unit 44A, 44B and 44C comprise the nozzle 60 to spray the mist whose diameter is 10 [μm] or less. When cooling the objects using the mist having such a small diameter, since the mist has a fine particle diameter and is vaporized without transiting a liquid state, this mist does not wet the cooling objects.

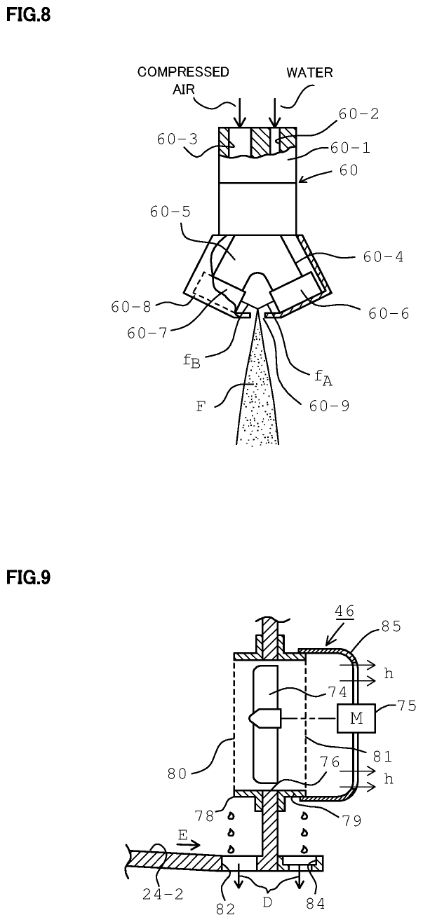

Therefore, this mist is referred to as the dry mist. The configuration for forming the dry mist, which includes the nozzle, is configured by forming water particles whose particle diameter is large by means of injecting the water from the nozzle, colliding the compressed air to the above water particles, and decomposing the above water particles into the dry mist. As such a collision-type nozzle, two-fluid type fine particle nozzle is known. In the present embodiment, a configuration having the two-fluid type fine particle nozzle is also used in the present embodiment (Patent Documents 4 and 5). In the present embodiment, the two-fluid type nozzle whose product name is “AKIJet” (Registered Trademark) manufactured by “H. IKEUCHI and Co., LTD.” is used. The schematic structure is simply shown in FIG. 8. The body 60-1 comprises a water inflow passage 60-2 and a compressed air inflow passage 60-3. The body 60-1 is branched into nozzle supports 60-4 and 60-5 in a fork shape. The nozzle body supports 60-4 and 60-5 comprise a water passage (not shown) which is connected to the water inflow passage 60-2 of the body 60-1 and a compressed air passage (not shown) which is connected to the compressed air inflow passage 60-3 of the body 60-1. The nozzle body supports 60-4 and 60-5 are connected to nozzle supports 60-6 and 60-7, respectively. The nozzle supports 60-6 comprises an inner water injection nozzle which is connected to an interior of the water passage of the nozzle body support 60-4, and an outer compressed air injection nozzle which is concentric to the inner water injection nozzle and is connected to an interior of the compressed air passage of the nozzle body support 60-4. The nozzle supports 60-7 comprises an inner water injection nozzle which is connected to an interior of the water passage of the nozzle body support 60-5, and an outer compressed air injection nozzle which is concentric to the inner water injection nozzle and is connected to an interior of the compressed air passage of the nozzle body support 60-5. By using the nozzle having the above structure, the two kinds of two-fluid injection flows f_{A} and f_{B} constituted by the inner water and the outer compressed air can be obtained. By the collision of the two kinds of the parallel injection flows f_{A} and f_{B}, the ultrafine mist F can be obtained (refer to the descriptions of Patent Documents 4 and 5 in detail). The nozzle body supports 60-4 and 60-5 and the nozzle supports 60-6 and 60-7 are covered by a cover 60-8, and an opening 60-9 which is a passage of the mist F is disposed at a center portion of the cover 60-8. As described below, each of the spraying units 44A, 44B and 44C has twenty four nozzles 60 (FIG. 7). The water inflow passage 60-2 and the compressed air inflow passage 60-3 of each of the nozzles 60 are a water supply pump (not shown) and an air compressor (not shown) through common water supply pipes (not shown) and common compressed air supply pipes (not shown), respectively. In the water supply pipes and the compressed air supply pipes, the water amount, the water pressure, the compressed air flow amount and the compressed air pressure can be measured.

In the present embodiment, as shown in FIG. 7, each of the spraying units 44A, 44B and 44C comprises four longitudinal units 62 having six nozzles 60 whose injection portion (the opening 60-9 in FIG. 8) is directed to downward. That is, each of the spraying units 44A, 44B and 44C comprises twenty four nozzles 60 (a grand total=6×4=24). As shown in FIG. 5, the downward mist F is simultaneously injected from the nozzles 60 of the respective spraying units 44A, 44B and 44C. The respective four longitudinal units 62 are fixed to the support frame 64, and are referred to as the spraying units 44A, 44B and 44C. The downward mist F from the nozzles 60 is directed to the molded resin products M on the jigs 30 (FIG. 5), and the cooling of the molded resin products M is performed. As shown in FIG. 5, the respective spraying unis 44A, 44B and 44C are attached to the corresponding support members 66, the respective support members 66 are coupled to corresponding lifting and lowering apparatuses (not shown) (for example, winch-type lifting and lowering apparatuses), and the spraying units 44A, 44B and 44C can be lifted or lowered (indicated by an arrow “g”) by the corresponding lifting and lowering apparatuses so that the height position adjustments of the spraying units 44A, 44B and 44C for the molded resin products mounted on the jigs 30 can be performed. That is, the optimal height position of the nozzles 60 for the molded resin products is existed depending on the height of the molded resin products which are the cooling objects. For example, in a case that the inner fender of the vehicle (which is the molded resin product M in the present embodiment) is selected as the molded resin product, as shown in FIG. 5, the height of the spraying units 44A, 44B and 44C is relatively higher. In a case that the vehicle body undercover is selected as the molded resin product which is the cooling object, since the vehicle body undercover has a flat shape, it is preferred that the height of the nozzles 60 be lower than that of the height position shown in FIG. 5. However, since it is necessary to avoid the interference between the nozzles 60 and the rotational units 52 of the dividing walls 32, the nozzles 60 cannot lower below the line “L” along the top end of the rotational units 52 of the dividing walls 32.

Next, the opening and closing means of the inlet 34 and the outlet 38 in the cooling chamber 24 will be described. The film having a sufficient thickness (the transparent plate), which is transparent for the interior observation, and has a strength in which the break is not occurred in applying the load when the open operation or the close operation is performed, is bonded to (is fitted into) the rectangular frame of the door 36. The door 36 is slidable in the upward direction and the downward direction by the guide plates 72a and 72b extending to the longitudinal direction (the vertical direction) at the both ends (FIGS. 4 and 7). The door 36 comprises a lateral bar 36-1 extending to the lateral direction at the middle height of the door frame (FIG. 5). The lower end of the piston rod 37-1 of the pneumatic pressure cylinder 37 is pivotally fit to the lateral bar 36-1. Thereby, the door 36 can move between the lower position (an imaginary line 36a) where the inlet 34 is closed, and the higher position shown by a solid line in FIG. 5 where the inlet 34 is opened, depending on the expansion and the contraction of the piston rod 37-1 of the pneumatic pressure cylinder 37. The configuration for the lifting or the lowering of the door 40 to open or close the outlet 38 is similar to that of the door 36. Both ends of the door 40 are slidably guided in the longitudinal direction by the guide plates 73a and 73b. The door 40 is liftable and lowerable between the lower position shown by the solid line of FIG. 5 where the outlet 38 is closed, and the upper position shown by the imaginary line where the outlet 38 is opened, depending on the expansion and the contraction of the piston rod 41-1 of the pneumatic pressure cylinder 41 which is coupled to the lateral bar 40-1 extending to the lateral direction at the middle height of the door frame.

The discharge unit 46 is disposed for forcibly discharge of the water vapor which is generated by vaporizing the mist (the ultrafine water droplets) when cooling the molded resin products. That is, in the present invention, the system that the water droplets are vaporized (are turned into the water vapor) by spraying the mist to the hot molded resin products ejected from the molding press 10 and the molded resin products are cooled by the latent heat of the vaporization, is used. The water vapor is filled in the interior space of the cooling chamber 24. In order to prevent from adhering the water droplets to the molded resin products due to the temperature decrease which is caused by the stagnation of the water vapor fora long term, a mechanism that forcibly discharges the water vapor in an interior space of the cooling chamber 24 is disposed. In the present invention, the discharge unit 46 also has a separation function of the dew condensation water. As shown in FIG. 9, the discharge unit 46 comprises an electric discharge fan 74, and the discharge fan 74 is positioned at the discharge hole 76 disposed on the wall of the cooling chamber 24. The rotational shaft of the discharge fan 74 is coupled to the electric motor 75, the draining punching plates 80 and 81 are disposed at a front portion of a shroud 78 and a back portion of a shroud 79, respectively, and drain holes 82 and 84 are disposed on the bottom wall 24-2 of the cooling chamber just below the draining punching plates 80 and 81. The electric motor 75 is disposed at the center of the cover 85 fixed to the shroud 79 which is located at an exterior of the cooling chamber 24. Forcible flow (arrows “h”) from the interior of the cooling chamber 24 to the exterior of the cooling chamber 24 through the discharge hole 76 and a vent hole of the cover 85 is generated by the rotation of the discharge fan 74, and the forcible discharge of the water vapor can be performed. When the water vapor passes through the draining punching plates 80 and 81, the water droplets which can slightly be contained in the water vapor are adhered to the plates around the discharge hole 76, are dropped to the drain holes 82 and 84, and can be drained from the drain holes 82 and 84. The dew condensation water which can be generated in an interior space of the cooling chamber 24 by the excessive mist or the stagnation of the water vapor is naturally flown to the drain holes 82 and 84 by the inclination of the bottom wall 24-2 of the cooling chamber (an arrow “E”), and is collected in the drain holes 82 and 84 (arrows “D”). It seems that the discharge unit 46 is disposed on only one wall (the side wall 24-4), as shown in FIG. 5. Actually, the discharge units 46 are also disposed the other three walls as simply shown in the overall view of FIG. 1.

A schematic operation of the above-described apparatus will be described. The dies are opened (the upper die 10-1 moves upwardly (FIG. 2)) when the molded resin product is still hot, the molded resin product M (FIG. 3A) is ejected by the robot 18. The robot 18 comprises a sucker 18-2 (FIG. 5) that is disposed at the tip of the articulated arm 18-1, and sucks and holds the molded resin product M on the lower die 10-2 of the molding press 10. When the molded resin product M is ejected from the molding press 10, in the dry mist cooling device 12, one of the jigs 30 on the rotational stage 26 (the No. 1 jig in FIG. 4) is positioned at the setting position “A” faced on the inlet 34, another of the jigs 30 on the rotational stage 26 (the No. 2 jig in FIG. 4) is positioned at the ejecting position “C” for the molded resin product faced on the outlet for the molded resin product, and the other of the jigs 30 on the rotational stage 26 (the No. 3 jig in FIG. 4) is positioned at the intermediate position “B”. That is, the above three jigs 30 are at the stop position (FIG. 4), the rotation of the rotational stage 26 is stopped, the door 36 moves upwardly, the inlet 34 is opened, the articulated arm 18-1 of the robot 18 in which the molded resin product M is held by the sucker 18-2 is introduced to the interior of the cooling chamber 24 through the inlet 34, the molded resin product M is mounted on the jig 30 faced on the inlet 34, and the suction operation by the sucker 18-2 is stopped. The molding resin product which is correctly mounted on the jig 30 after the sucker 18-2 stops the suction operation is shown by the imaginary line M′. The articulated arm 18-1 of the robot 18 is retreated to the exterior of the cooling chamber 12, the door 36 is lowered to the closed position by the expansion of the piston rod 37-1 of the pneumatic pressure cylinder 37, and the door 36 closes the inlet 34 (the imaginary line 36a in FIG. 5). In contrast, the door 40 is lifted to the opened position (the imaginary line 40a in FIG. 5) by the contraction of the piston rod 41-1 of the pneumatic pressure cylinder 41 in the outlet 38 faced on the jig 30, the outlet 38 is opened, the articulated arm 20-1 of the robot 20 in which the sucker 20-2 is disposed at the tip thereof is introduced to the interior of the cooling chamber 24 through the outlet 38, the sucker 20-2 is attached to the upper face of the molded resin product mounted on the jig 30, and the sucker 20-2 begins the suction operation. The articulated arm 20-1 of the robot 20 is retreated, the molded resin product M is ejected from the jig 30 shown by the imaginary line, is ejected from the cooling chamber 24 through the outlet 38, and is conveyed to the above-described trimming press 14. The door 40 is lowered to the closed position by the expansion of the piston rod 41-1 of the pneumatic pressure cylinder 41, and the outlet 38 is closed. As described above, the setting operation of the molded resin product for cooling in the interior of the cooling chamber 24 and the ejection operation of the molded resin product after the cooling is completed are simultaneously performed. Spraying the dry mist from the nozzles in the spraying unit 44A positioned at the setting position “A” and the spraying unit 44C positioned at the ejecting position “C” for the molded resin product is stopped while the setting operation to the molded resin product and the ejecting operation to the molded resin product are performed. With reference to the spraying unit 44B positioned at the intermediate position “B”, spraying the dry mist to the molded resin product M on the jig 30 positioned at the intermediate position “B” is continued. That is, the rotational unit 52 of the dividing wall 32 fixed to the support 28 is alignment with the fixed unit 54 of the dividing wall 32 fixed to the lower surface of the upper wall 24-1 of the cooling chamber 24 in the stop position of FIG. 4 (FIG. 5), the molded resin product M on the jig 30 positioned at the intermediate position is shielded by the dividing walls 32 from both sides (FIG. 4), a substantially closed space is formed between the dividing walls 32, the leakage of the mist from the spraying unit 44B to the exterior of the cooling chamber is substantially prevented, and the cooling of the molded resin product by spraying the dry mist to the molded resin product can be continued.

In a state that the rotational stage 26 is stopped, setting the molded resin product which is required for cooling, ejecting the molded resin product after cooling, and closing the inlet 34 and the outlet 38 are completed, the rotational moving of the rotational stage 26 is resumed, and spraying the mist from the nozzles 60 in the spraying unit 44A positioned at the setting position “A” and the spraying unit 44C positioned at the ejecting position “C” for the molded resin product is also resumed. When the moving of the rotational stage 26 is progressed, the molded resin product Mon the jig positioned at the setting position “A” is apart from the spraying unit 44A, the spraying unit 44B is close to the molded resin product M, and then the spraying amount in which the molded resin product M on the jig which was positioned at the setting position “A” is received is maintained to be a substantially constant value. The same phenomenon is also applied to the molded resin product M on the jig which was positioned at the intermediate position “B”. That is, the molded resin product M on the jig which was positioned at the intermediate position “B” is apart from the spraying unit 44B and is close to the spraying unit 44C. The spraying amount in which the molded resin product M on the jig is received is designed not to largely be varied to the rotation of the rotational stage 26 in spite of fixedly arrangement of the spraying units 44A, 44B and 44C.

Next, the interlocking between the molding operation in the molding press 10 and the cooling operation in the cooling device 12 will be described. The molding process of the molded resin product M in the molding press 10 (FIG. 2) is repeatedly performed by lifting the upper die 10-1 for the die opening, ejecting the molded resin product, supplying the raw material, lowering the upper die 10-1 for the die closing, and maintaining the pressurization. On the contrary, the cooling process by the dry mist cooling device 12 is repeatedly performed by setting the molded resin product M which is conveyed from the molding press 10 and is required for cooling, on the jig 30 positioned at the setting position “A” when the rotational table 26 is stopped, ejecting the molded resin product M after cooling at the ejecting position “C” when the rotational table 26 is stopped, and rotating the rotational table to the next stop position by 120 [deg]. In the present embodiment of the present invention, basically, the rotational stage 26 is stopped while the molded resin product is ejected from the molding press 10, the raw material is supplied to the molding press 10, the molded resin product is set to the jig 30 on the rotational stage 26 and the molded resin product after cooling is ejected from the jig 30, and the rotational stage 26 rotates around the support while the die maintains the pressurization (the process that the sheet S is molded to the molded resin product). Thereby, the operation of molding in the press molding apparatus 10 is synchronized with the rotating operation and the stopping operation of the rotational stage 26 in the cooling device 12. Thus, the time in which the rotational stage 26 rotates by 120 [deg] is equal to the time for maintaining the pressurization in the molding press 10. In other words, the rotational velocity of the rotational stage 26 is determined by the time for maintaining the pressurization in the molding press 10. With reference to cooling the molded resin products by spraying the dry mist in the cooling chamber, since the doors 36 and 40 are opened in the setting position “A” and the ejecting position “C” when the rotational stage is stopped, the spraying units 44A and 44C are stopped the spraying operation so that the mist is not leaked to the exterior to the cooling chamber. The doors 36 and 40 are closed while the rotational stage 26 rotates. In a state that the doors 36 and 40 are closed, the spraying units 44A and 44C spray the mist. In contrast, with reference to the spraying unit 44B positioned at the intermediate position, even when the doors 36 and 40 are opened, both sides of the intermediate position from the rotational stage 26 to the upper wall 24-1 of the cooling chamber 24 is closed by the dividing walls 32 (FIGS. 4 and 5). Spraying the mist in the space of the intermediate position is performed in the substantially complete closed space. Since the mist is not leaked to the exterior of the intermediate position, spraying the mist in the intermediate position is continued while the rotational stage is stopped. In the present embodiment, the molded resin product is set to the cooling device at the setting position “A”. After the doors 36 and 40 are closed, the above molded resin product is sprayed the dry mist (cooling) until the doors 36 and 40 are opened for ejecting the molded resin product at the ejecting position “C”. During the spraying time, the molded resin product is required for decreasing (being cooled) up to the desired temperature. In order to perform the needed cooling, it is necessary to perform the settings such as the water amount, the water pressure, the compressed air pressure, a spraying distance, a temperature of the cooling chamber, and a spraying time (an operation time of the spraying unit). Since the operation time of the spraying unit is indirectly affected from the operation velocities of the robots 18, 20 and 22 and the doors 36 and 40, the optimal adjustments of these factors are also required. In a case that the thickness of the molded resin product is especially thick or the molded resin product has an uneven thickness, the desired operation can be performed by the adjustments of the water amount, the water pressure and the compressed pressure.

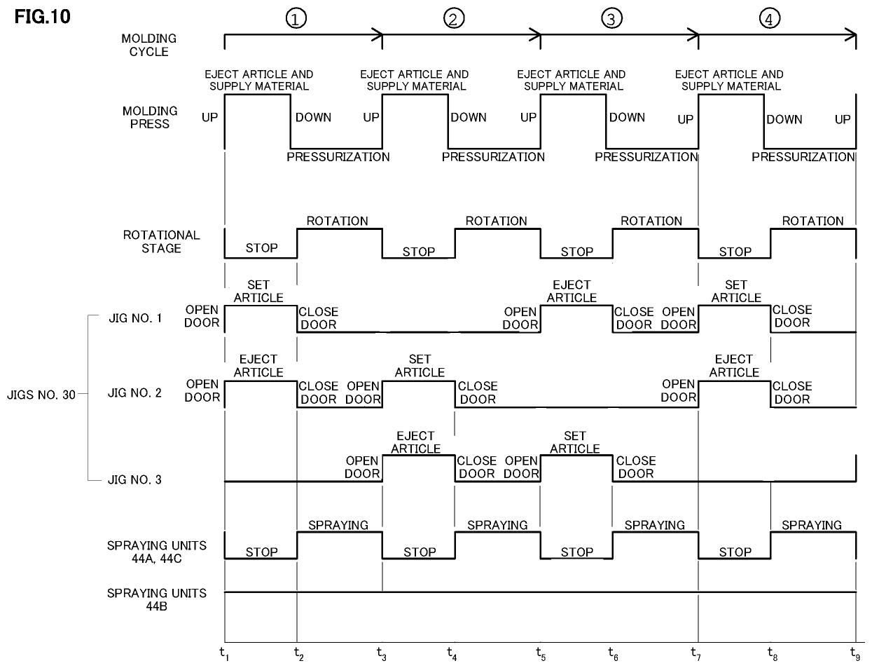

The interlocking between the molding operation in the molding press and the cooling operation in the cooling device, as schematically described above, will further be described in detail with reference to a schematic timing chart of FIG. 10. In FIG. 10, encircled numbers 1 to 4 shows a four-cycle sequential molding operation which is configured by the operations of ejecting the molded resin product and supplying the raw material in a state that the upper die is lifted and the dies are opened, and the operation of pressurization in a state that the upper die is lowered and the dies are closed. For convenience of explanation, as shown in FIG. 4, the operation is started in a state that the No. 1 jig 30 (on which no molded resin product is mounted) in the three jigs 30 in which the cooling device has, is positioned at the setting position “A”, the No. 2 jig 30 (on which the molded resin product after the cooling is completed is mounted) is positioned at the ejecting position “C” and the rest No. 3 jig 30 (on which the molded resin product during cooling is mounted) is positioned at the intermediate position “B”, and the rotational stage is stopped. The molding of the molded resin product M from the sheet S in the molding press 10 is completed, and the upper die 10-1 is lifted from the lower die 10-2. When the doors 36 and 40 of the cooling chamber 24 are opened, the setting of the molded resin product M from the molding press 10 in the No. 1 jig 30 positioned at the setting position “A” is started, the ejecting of the molded resin product M after the cooling is completed in the No. 2 jig 30 positioned at the ejecting position “C” is started, and the spraying units 44A and 44C are stopped (at a time point t₁). While the rotational stage 26 stopped, the spraying units 44A and 44C are stopped. In contrast, the spraying unit 44B positioned at the intermediate position “B” continues spraying the mist while the spraying units 44A and 44C are stopped. When supplying the sheet for the next molding operation is completed in the molding press 10, the upper die 10-1 of the molding press 10 is lowered to the lower die 10-2 and the molding of the molded resin product M is started by maintaining pressurization. Since the setting of the molded resin product M and the ejecting of the cooled molded resin product M are completed, the doors 36 and 40 are closed slightly after the lowering the upper-die 10-1 is started. Then, spraying the dry mist from the spraying units 44A and 44C is started and the rotational stage 26 also begins to rotate (at a time point t₂). When the required time for maintaining pressurization is elapsed in the molding press, the upper die is lifted, spraying the dry mist from the spraying units 44A and 44C is stopped, and the rotation of the rotational stage 26 is also stopped. In this time, the No. 3 jig 30 is positioned at the ejecting position “C” and the No. 2 jig 30 is positioned at the setting position “A”. The doors 36 and 40 are opened, the setting of the molded resin product M in the No. 2 jig 30 positioned at the setting position “A” is started, and the ejecting of the molded resin product M after the cooling is completed in the No. 3 jig 30 positioned at the ejecting position “C” is also started (at a time point t₃). When the raw material is supplied in the molding press for preparation of the molding, the molding press (the upper die) is lowered and the molding of the molded resin product M is started by maintaining pressurization. Spraying the dry mist from the spraying units 44A and 44C and the rotation of the rotational stage 26 are resumed slightly after the molding of the molded resin product M is started (at a time point t₄). When the predetermined time for maintaining pressurization is elapsed in the molding press, the upper die is lifted and spraying the dry mist from the spraying units 44A and 44C and the rotation of the rotational stage 26 are stopped. In this time, the No. 1 jig 30 is positioned at the ejecting position “C” and the No. 3 jig 30 is positioned at the setting position “A”. The doors 36 and 40 are opened, the molded resin product M is set to the No. 3 jig 30 positioned at the setting position “A” and the molded resin product M after the cooling is completed is ejected from the No. 1 jig 30 positioned at the ejecting position “C” (at a time point t₅). When the sheet is supplied in the molding press for preparation of the next molding, the upper die of the molding press is lowered and the molding of the next molded resin product M is started by maintaining the pressurization. The doors 36 and 40 are closed slightly after lowering the upper die, and spraying the dry mist from the spraying units 44A and 44C and the rotation of the rotational stage 26 are resumed (at a time point t₆). When the predetermined time for maintaining the pressurization is elapsed in the molding press, the upper die is lifted, and spraying the dry mist from the spraying units 44A and 44C and the rotation of the rotational stage 26 are stopped. In this time, the No. 1 jig 30 is positioned at the setting position “A” and the No. 2 jig 30 is positioned at the ejecting position “C” (at a time point t₇). After that, the above-described processes are repeated, and the operation of the cooling device in the fourth time operation cycle of the molding press is shown in the timing chart. The rotational stage is stopped while the sheet material is set in the molding press, and the setting of the molded resin product M and the ejecting of the cooled molded resin product M are performed. The upper press die is lowered, the operation for maintaining the pressurization is started, the doors are closed, and the rotational stage begins to rotate (at a time point t₈). When the operation for maintaining the pressurization in the press die is completed, the upper die is lifted and the rotation of the rotational stage is stopped (at a time point t₉).

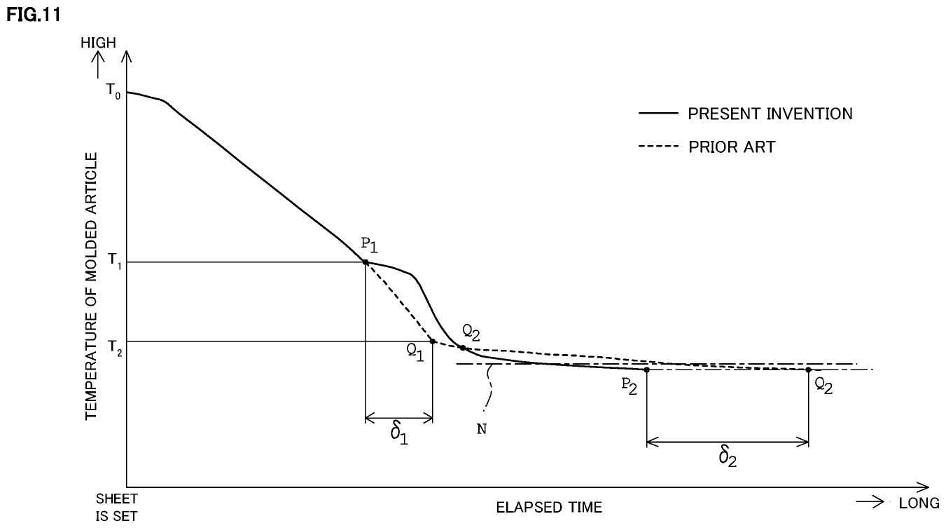

FIG. 11 shows a relationship between an elapsed time from setting the sheet piece S to the molding press 10 and the temperature of the molded resin product. The temperature in setting the sheet piece is about 120° Celsius (T₀) in a case that the resin raw material is polypropylene. In a case of the present invention shown by the solid line, the molding press 10 is opened (the upper die 10-1 is lifted) at the time when the temperature decreases T₁ which is about 80° Celsius (at a timing P₁), and the molded resin product is ejected. Since the molded resin product is not contact with the die due to ejecting the molded resin product, the decrease velocity of the temperature becomes slow once. When the molded resin product is set to the dry mist cooling device 12 and is sprayed with the dry mist, the cooling of the molded resin product is rapidly progressed by utilizing the vaporization of the dry mist. When the temperature of the molded resin product decreases up to about 40° Celsius, the cooling velocity becomes slow again. A line “N” in FIG. 11 indicates the upper limit temperature in which the trimming of the molded resin product can be performed, and in a case that the raw material is polypropylene, the upper limit temperature is about 40° Celsius. When the temperature of the molded resin product decreases the temperature which is slightly lower than the temperature shown by the line “N” in which the trimming can be performed (about 35° Celsius) (at a timing P₂), the cooling is completed, and the molded resin product is ejected from the cooling device. In a case that the cooling of the molded resin product is performed by the cooling fans depending on the prior art, an example of the cooling operation is shown by the broken line. In a case that the cooling is performed by the conventional conveyor and the conventional cooling fans, the temperature decrease of the molded resin product varies along the same line of the present invention until the die is opened. The timing of ejecting the molded resin product from the die is indicated by “Q₁”, and is considerably slower than that of the present invention (at the timing P₁). The molded resin product is cooled by the cooling wind of the cooling fans after the molded resin product is ejected from the die. The timing of completing the cooling when the temperature of the molded resin product becomes slightly lower than the temperature shown by the line “N” in which the trimming can be performed is indicated by “Q₂”. Compared with the present invention and the prior art, the ejecting timing of the molded resin product from the molding press 10 is advanced from the timing Q₁ in the prior art to the timing P₁. As shown in FIG. 11, it is understood that the ejecting timing is advanced by δ₁ [sec] (about 4 [sec] in the present embodiment). This means that the molding time in one cycle is shortened by δ₁ [sec], and it is understood that the production speed of the molded resin product can be enhanced by the shortening of the molding time in one cycle (5 [sec] per one cycle). In contrast, with reference to the cooling time, in a case that the comparison of the time from ejecting the molded resin product to completing the cooling in the molding press 10 is performed, the above timing is “P₂” in the present invention and is “Q₂” in the prior art. Compared with the timing Q₂ in the prior art, the present invention is shortened by δ₂ [sec] (about 50 [sec] in the present embodiment). This means that the present invention can complete the cooling earlier than the prior art, despite that the timing of the ejecting of the molded resin product from the molding press 10 in the present invention is earlier than that in the prior art. It is meant that the cooling method using the dry mist of the present invention is more excellent than the conventional cooling method using the cooling fans.

In the present embodiment according to the present invention, as described in the explanation of FIG. 10, rotating the rotational stage 26 by 120 [deg] corresponding to one cycle of the adjacent cooling device 12 is performed in the time for maintaining the pressurization in one cycle of the molding process of the molding press 10. This means that the rotational velocity of the rotational stage 26 is determined depending on the time for maintaining the pressurization. In other words, in accordance with the present embodiment, this also means that it is required that the rotational velocity of the rotational stage 26 is higher when the timing of the ejection of the molded resin product from the molding press 10 is earlier. When the rotational velocity of the rotational stage 26 becomes higher, the total spraying amount from the spraying apparatus (the spraying units 44A, 44B and 44C) is reduced, and it is possible that the cooling of the molded resin product is inadequate. In such a case, the countermeasure that the number of the jigs 30 increases from three in FIG. 4 to four can be taken. In this case, the rotational stage 26 rotates by 90 [deg] per one cycle of the cooling device. Since the 90 [deg] rotation is performed in the same time duration for maintaining pressurization, the rotational velocity of the rotational stage 26 can be slower. Ina case that the production speed of the molding press 10 does not become higher (in a case that the cycle time is long), the configuration that the number of the jigs 30 is two can be realized. In a case that the number of the jigs 30 is two, spraying the mist cannot be performed when the jigs are in a stop state. Since the cycle time is long and the rotational velocity can be slower, the desired cooling of the molded resin product can be performed by spraying the mist during the rotation.

### EXPLANATION OF REFERENCE NUMERALS

10 molding press
10-1 upper die
10-2 lower die
12 dry mist cooling apparatus
14 trimming press
15 workbench
16 scrap conveyor
18, 20, 22 articulated manipulator (robot)
24 cooling chamber
26 rotational stage
28 support
30 jigs for holding a molded resin product
32 dividing wall
34 inlet
36 door for an inlet
38 outlet
40 door for an outlet
42 electric motor
44A, 44B, 44C spraying unit
46 discharge unit
48 support stand
52 rotational unit of a dividing wall
54 fixed unit of a dividing wall
56 transmission
60 dry mist spraying nozzle
66 spraying unit support member
74 discharge fan
78, 79 shroud
80, 81 draining punching plate
82, 84 drain hole
A setting position for a molded resin product
B intermediate position
C ejecting position for a molded resin product
M integrated molded resin product for an inner fender
M₁, M₂ inner fender
S sheet piece
SR scraps

1. A cooling method of molded resin products, comprising steps of:
spraying mist to molded resin products which are ejected from a molding apparatus to mold a heated sheet of a synthetic resin and are in a hot state;
removing heat from said molded resin products by vaporizing said mist sprayed to said molded resin products under a heat amount in which said molded resin products have; and
cooling said molded resin products so that water droplets are not substantially attached to said molded resin products.

2. The cooling method of the molded resin products according to claim 1,
wherein a step of spraying said mist to said molded resin products is performed in a substantially closed space where said molded resin products are received.

3. The cooling method of the molded resin products according to claim 2,
wherein said molded resin products ejected from a die are sequentially supplied to said space for receiving said molded resin products,
said molded resin products after said cooling is completed are sequentially ejected from said space, and
said plural molded resin products are received in said space and are simultaneously cooled.

4. The cooling method of the molded resin products according to claim 2,
wherein said molded resin products are mounted on shape holding jigs so that influence of gravity is removed and shapes of said molded resin products are held while said mist is sprayed.

5. The cooling method of the molded resin products according to claim 1,
wherein water vapor generated in said space for receiving said molded resin products is always discharged.

6. A cooling device of molded resin products for performing the cooling method of the molded resin products according to claim 1, comprising:
a cooling chamber that receives said molded resin products, forms a space where cooling of said molded resin products is performed, and has an inlet for said molded resin products before said cooling and an outlet for said cooled molded resin products which are openable and closable by respective doors;
a rotational stage that rotates around a vertical axis in said cooling chamber;
plural jigs that are disposed on said rotational stage with an equal interval in a circumferential direction, hold shapes of said molded resin products, and retain said molded resin products to predetermined positions; and
a mist spraying apparatus that is disposed at an upper portion of said cooling chamber and sprays said mist to said molded resin products retained by said jigs,
wherein said rotational stage is stopped in a state that one of said jigs is faced on said inlet and another of said jigs is faced on said outlet, and
wherein said molded resin products are set on said jigs from said inlet, are sprayed with said mist and are conveyed to said outlet by rotation of said rotational stage.

7. The cooling device of the molded resin products according to claim 6,
wherein said jigs are three or more and are disposed on said rotational stage, and dividing walls are disposed between said jigs which are adjacent in a rotational direction.

8. The cooling device of the molded resin products according to claim 7,
wherein said respective dividing walls comprise:
a rotational unit which integrally rotates said rotational stage and is upwardly extended to just below a lowest position of said spraying apparatus; and
a fixed unit which is upwardly extended from just above said lowest position of said spraying apparatus to an upper wall of said cooling chamber, and
wherein said rotational unit of said jigs is alignment with said fixed unit in a vertical direction in a stop position of said rotational stage.

9. The cooling device of the molded resin products according to claim 6,
wherein said mist spraying apparatus is liftably and lowerably disposed in said cooling chamber.

10. The cooling device of the molded resin products according to claim 8,
wherein said mist spraying apparatus comprises plural spraying units which are correspondingly disposed above said respective jigs,
wherein said respective spraying units comprise plural nozzles disposed in longitudinal and lateral directions,
wherein said respective nozzles comprise passages connected to a compressed air source and a water source commonly, and
wherein said mist is generated by colliding an air flow to a water flow in each of said nozzles.

11. The cooling device of the molded resin products according to claim 6, further comprising forcible discharge means for discharging said cooling chamber.

12. The cooling device of the molded resin products according to claim 11,
wherein said forcible discharge means comprise a separation means which separates condensation water during discharge.

13. The cooling device of the molded resin products according to claim 6,
wherein a bottom surface of said cooling chamber forms an inclined surface which is lowered toward an outer circumference, and
wherein surplus water is collected at said outer circumference of said inclined surface.

14. The cooling method of the molded resin products according to claim 3,
wherein said molded resin products are mounted on shape holding jigs so that influence of gravity is removed and shapes of said molded resin products are held while said mist is sprayed.

15. The cooling device of the molded resin products according to claim 9,
wherein said mist spraying apparatus comprises plural spraying units which are correspondingly disposed above said respective jigs,
wherein said respective spraying units comprise plural nozzles disposed in longitudinal and lateral directions,
wherein said respective nozzles comprise passages connected to a compressed air source and a water source commonly, and
wherein said mist is generated by colliding an air flow to a water flow in each of said nozzles.

16. The cooling device of the molded resin products according to claim 9,
wherein said mist spraying apparatus comprises plural spraying units which are correspondingly disposed above said respective jigs,
wherein said respective spraying units comprise plural nozzles disposed in longitudinal and lateral directions,
wherein said respective nozzles comprise passages connected to a compressed air source and a water source commonly, and
wherein said mist is generated by colliding an air flow to a water flow in each of said nozzles.

17. The cooling device of the molded resin products according to claim 7, further comprising forcible discharge means for discharging said cooling chamber.

18. The cooling device of the molded resin products according to claim 17,
wherein said forcible discharge means comprise a separation means which separates condensation water during discharge.

19. The cooling device of the molded resin products according to claim 7,
wherein a bottom surface of said cooling chamber forms an inclined surface which is lowered toward an outer circumference, and
wherein surplus water is collected at said outer circumference of said inclined surface.
